(19) United States
(12) Patent Application Publication
(10) Pub. No.: US 2023/0102638 A1
(43) Pub. Date: Mar. 30, 2023

(54) TERMINATION BOX

(71) Applicant: COMMSCOPE TECHNOLOGIES LLC, Hickory, NC (US)

(72) Inventor: Paul David HUBBARD, Iron Station, NC (US)

(73) Assignee: COMMSCOPE TECHNOLOGIES LLC, Hickory, NC (US)

(21) Appl. No.: 17/908,490

(22) PCT Filed: Mar. 4, 2021
(86) PCT No.: PCT/US2021/020828

§ 371 Date: Aug. 31, 2022

Related U.S. Application Data
(60) Provisional application No. 62/984,894, filed on Mar. 4, 2020.

(51) Int. Cl. G02B 6/44; H02G 3/08

(52) U.S. Cl. CPC G02B 6/4447; H02G 3/081

(57) ABSTRACT

The present disclosure provides a termination box that secures and manages cables and provides an enclosed protected space for connection/splices. The termination boxes of the present disclosure protect the contents therein from being damaged due to impact. They also protect the contents from the environment, including from infestation by insects such as ants. The termination box is easily installed and easily fitted with the adapters, connectors, and cables.

### CROSS-REFERENCE TO RELATED APPLICATION

This application is being filed on Mar. 4, 2021 as a PCT International Patent Application and claims the benefit of U.S. Patent Application Ser. No. 62/984,894, filed on Mar. 4, 2020, the disclosure of which is incorporated herein by reference in its entirety.

### TECHNICAL FIELD

Telecommunication housings, in particular, a termination box.

### BACKGROUND OF THE INVENTION

Termination boxes are used for in-premise fiber termination. Termination boxes have a wide range of applications. For example, a termination box is commonly used to provide an enclosed housing in which a drop cable can be spliced to pigtails. It is desirable to optimize the design of termination boxes in terms of manufacturability and functionality.

### SUMMARY

The present disclosure provides a termination box that secures and manages cables and provides an enclosed protected space for connection/splices. The termination boxes of the present disclosure protect the contents therein from being damaged due to impact. They also protect the contents from the environment, including from infestation by insects such as ants. The termination box is easily installed and easily fitted with telecommunication components such as splices, adapters, connectors, and cables.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following Detailed Description. Embodiments of the present disclosure will hereinafter be described in conjunction with the appended drawings, wherein like numerals denote like elements.

FIG. 1 is a top isometric view of an embodiment of a termination box according to the present disclosure;

FIG. 2 is a bottom isometric view of the termination box of FIG. 1;

FIG. 3 is a top exploded isometric view of the termination box of FIG. 1;

FIG. 4 is a bottom exploded isometric view of the termination box of FIG. 1;

FIG. 5 is an enlarged portion of FIG. 4;

FIG. 6 is an isometric view of the base of the termination box of FIG. 1;

FIG. 7 is an isometric view of the base of the termination box of FIG. 1;

FIG. 8 is an enlarged portion of FIG. 7;

FIG. 9 is an enlarged portion of FIG. 7;

FIG. 10 is an enlarged portion of FIG. 7;

FIG. 11 is a top view of the base of the termination box of FIG. 1;

FIG. 12 is a side view of the termination box of FIG. 1;

FIG. 13 is a side view of the base;

FIG. 14 is a front view of the termination box of FIG. 1;

FIG. 15 is a front view of the base;

FIG. 16 is a rear view of the termination box of FIG. 1;

FIG. 17 is a rear view of the base;

FIG. 18 is a top view of the termination box of FIG. 1;

FIG. 19 is a cross-sectional view along line 1-1 of FIG. 18;

FIG. 20 is a cross-sectional view along line 2-2 of FIG. 18;

FIG. 21 is an enlarged portion of FIG. 20;

FIG. 22 is an isometric view of FIG. 20;

FIG. 23 is an enlarged portion of FIG. 22;

FIG. 24 is a cross-sectional view along line 3-3 of FIG. 18; and

FIGS. 25-41 are views of the termination housing with telecommunication components arranged within various configurations.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION

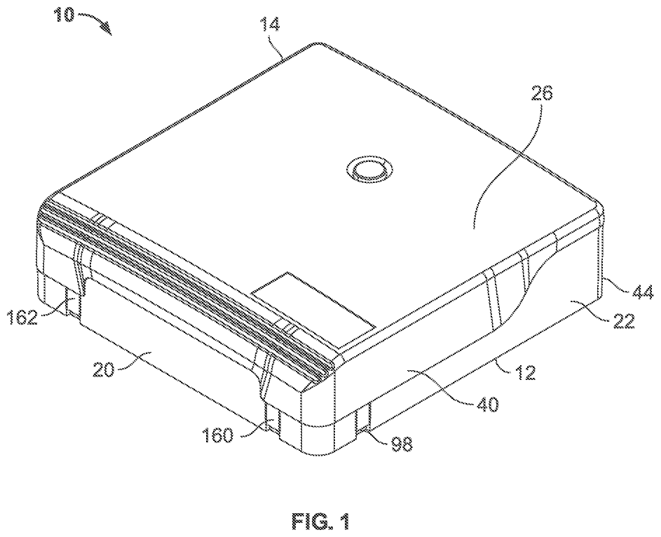

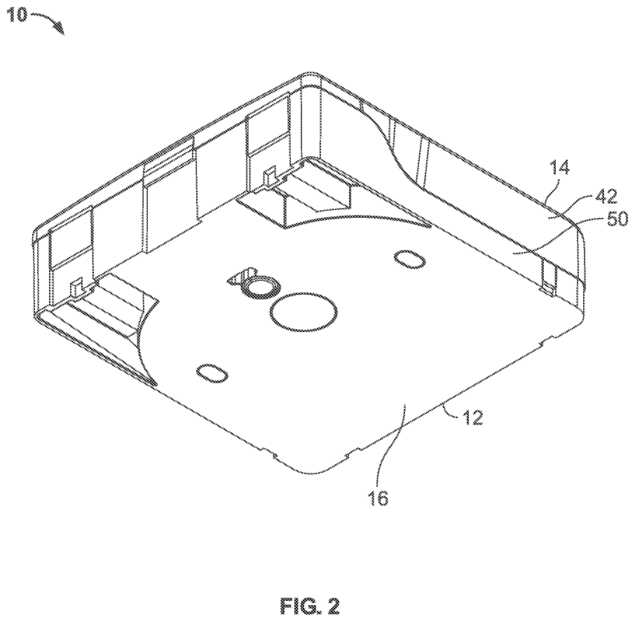

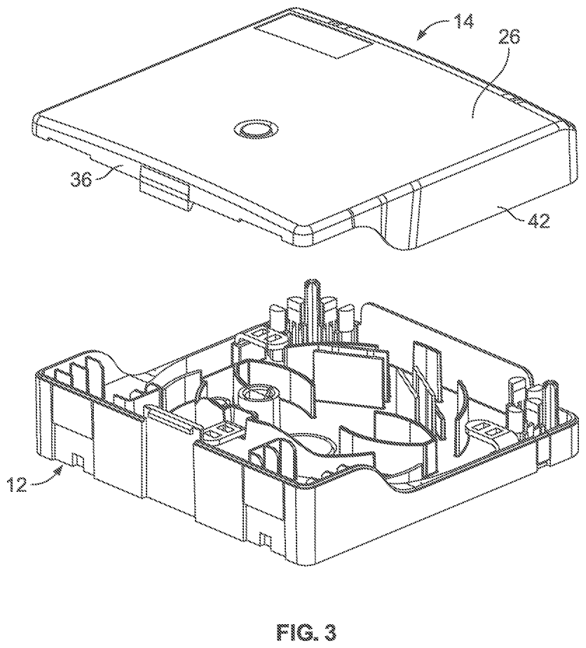

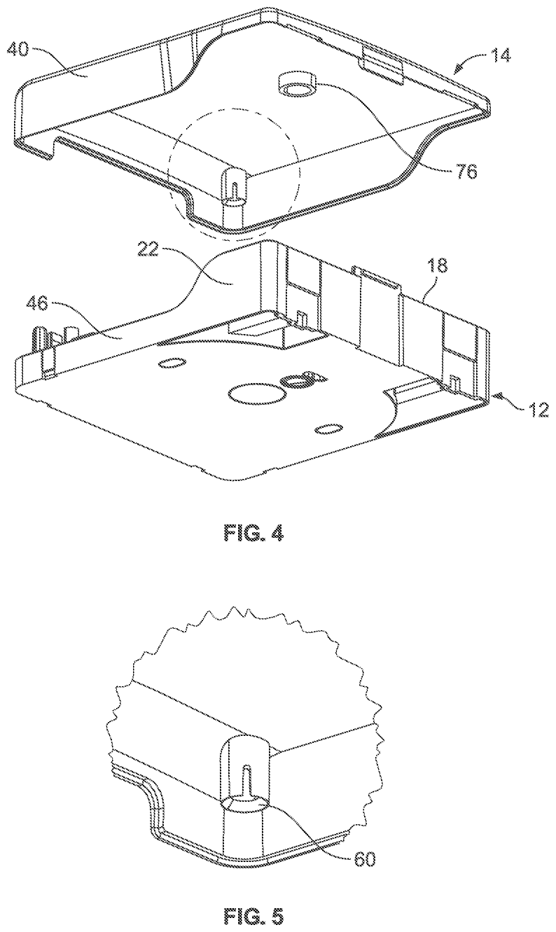

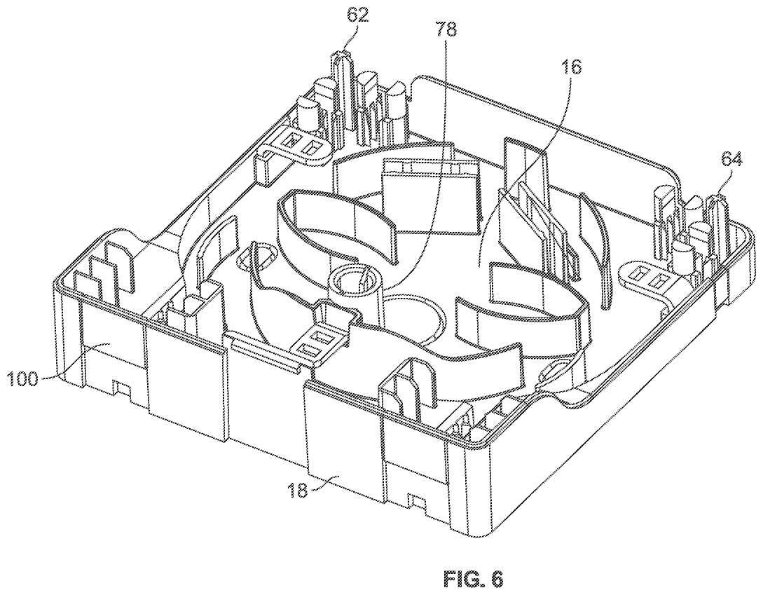

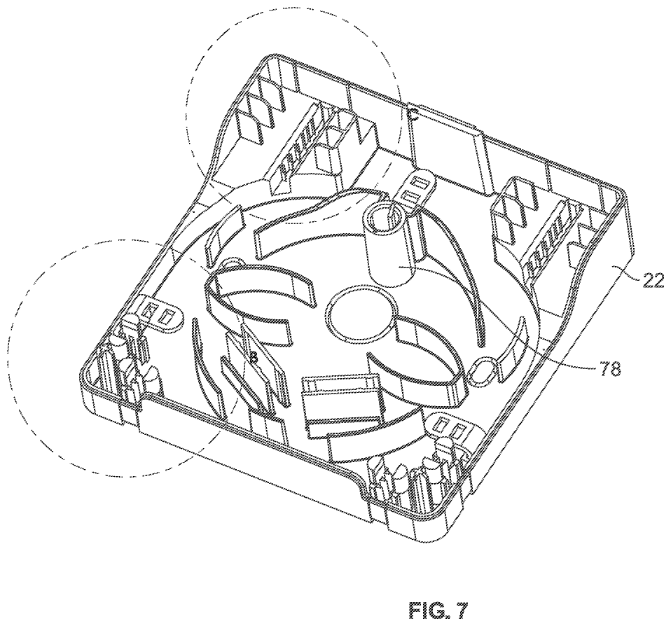

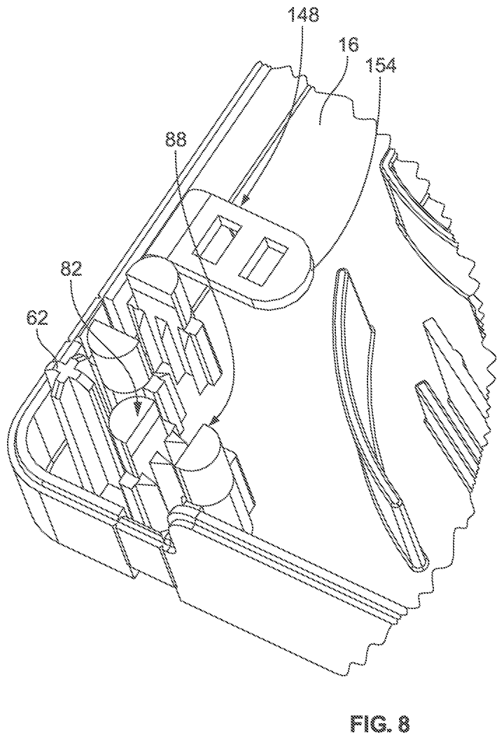

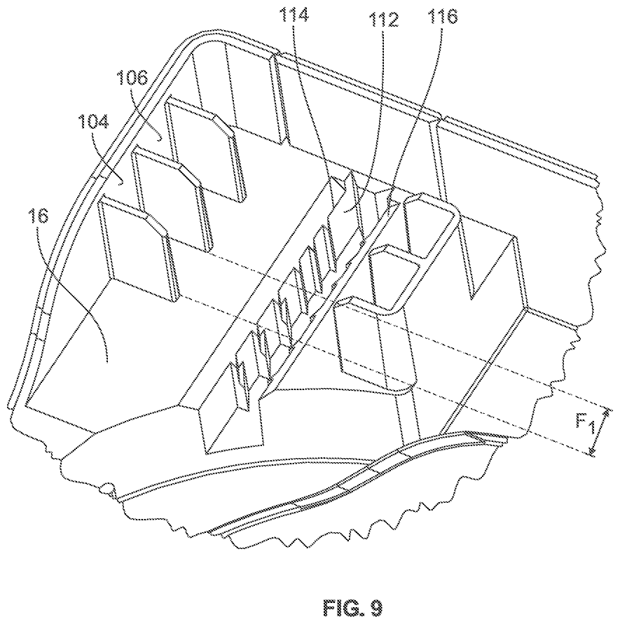

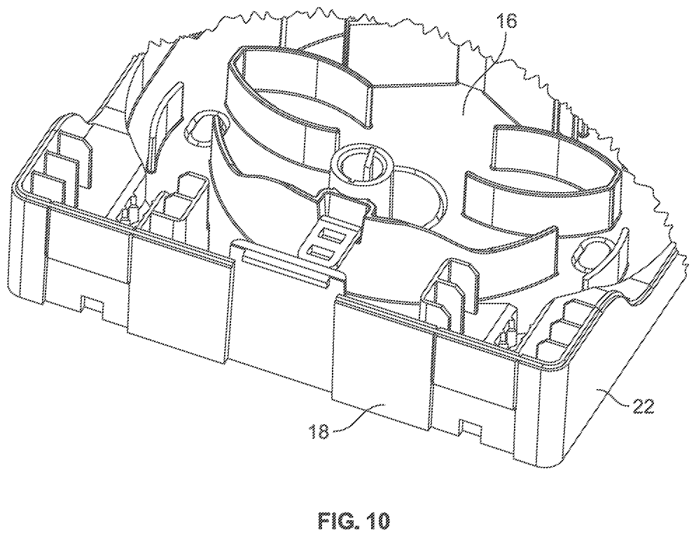

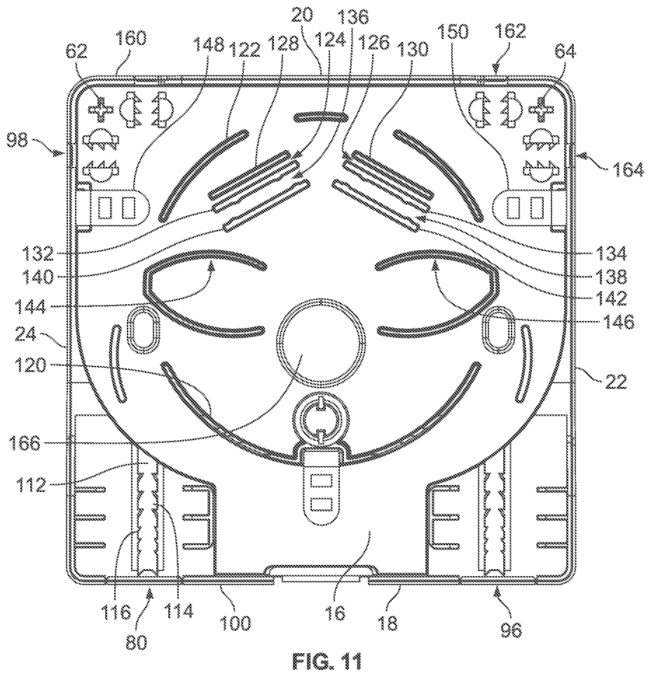

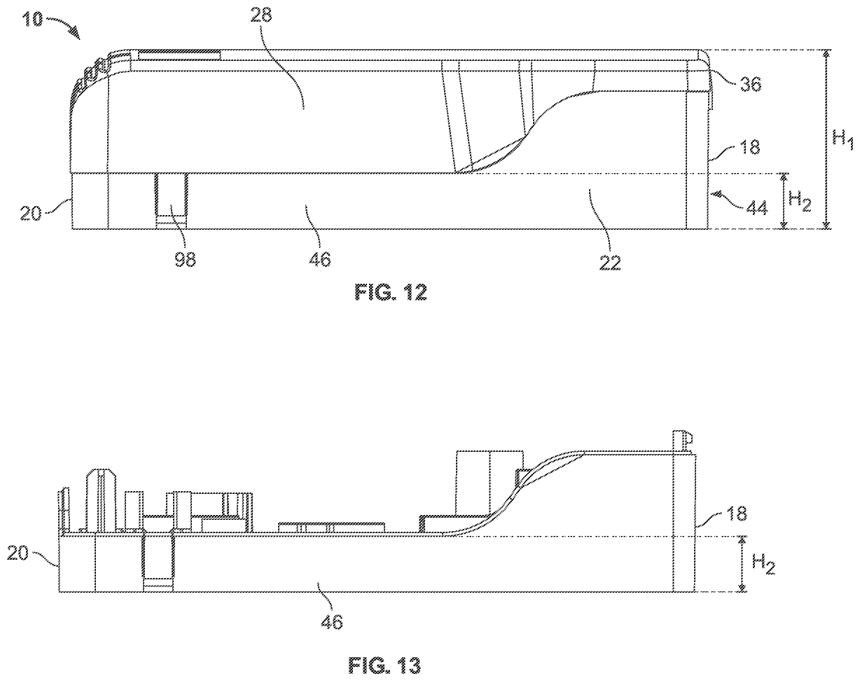

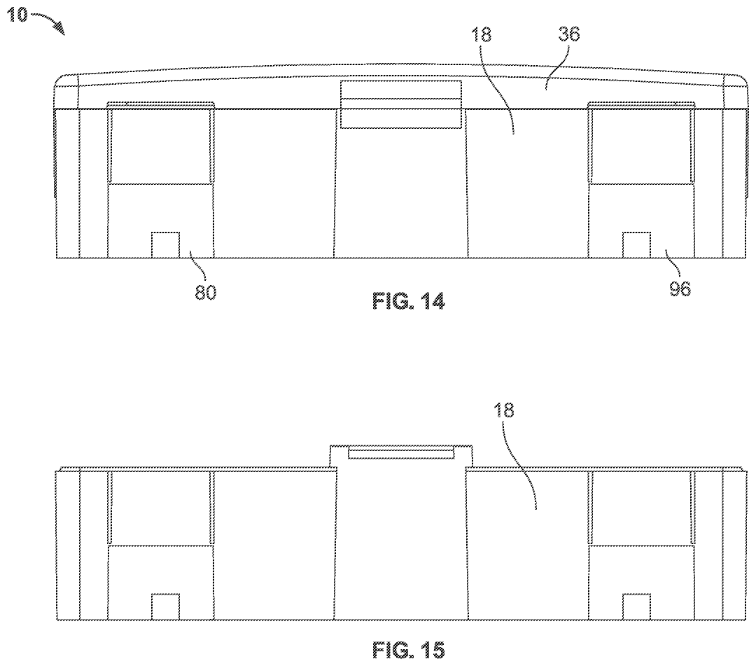

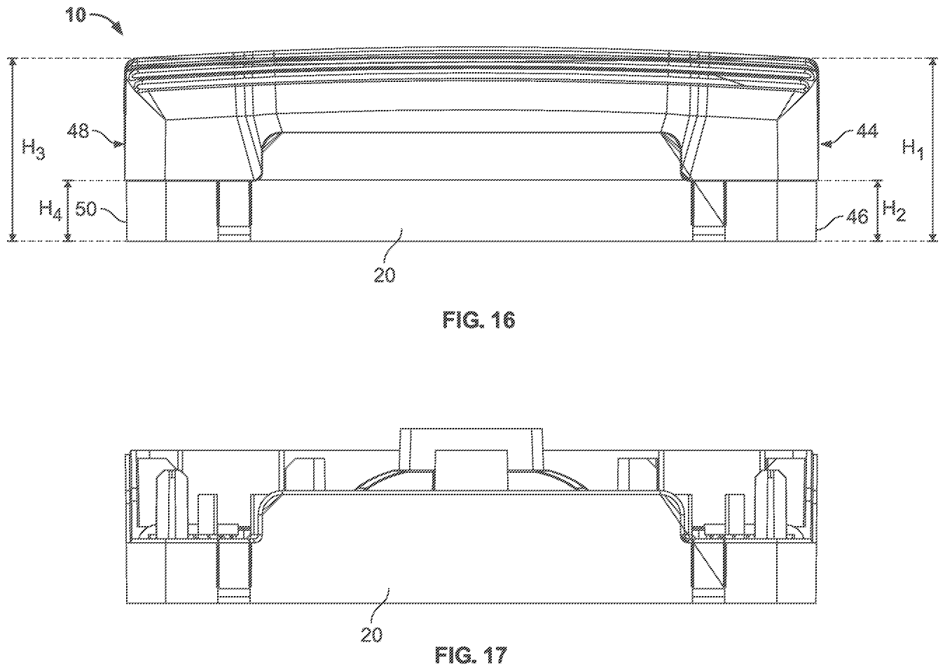

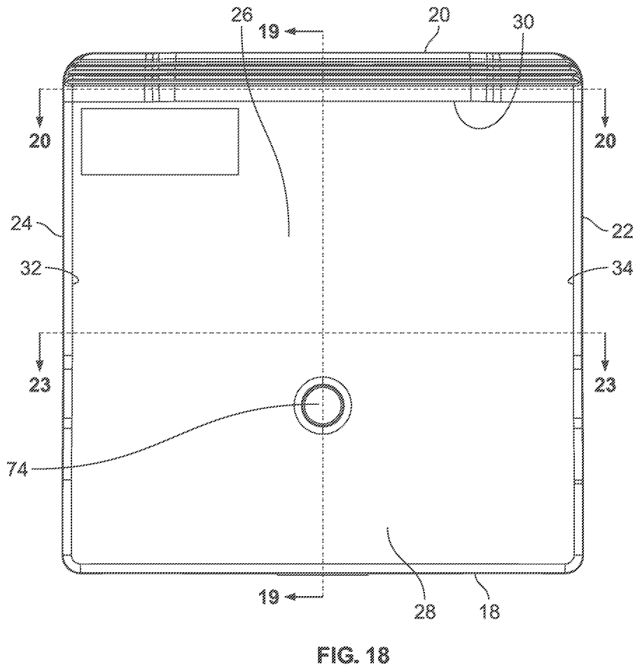

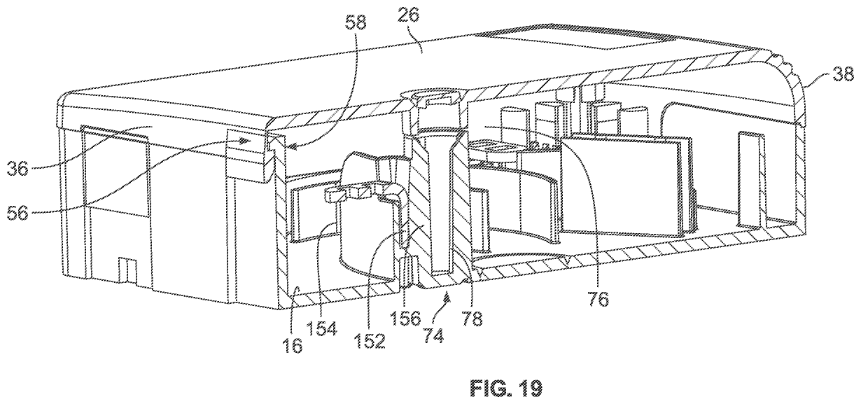

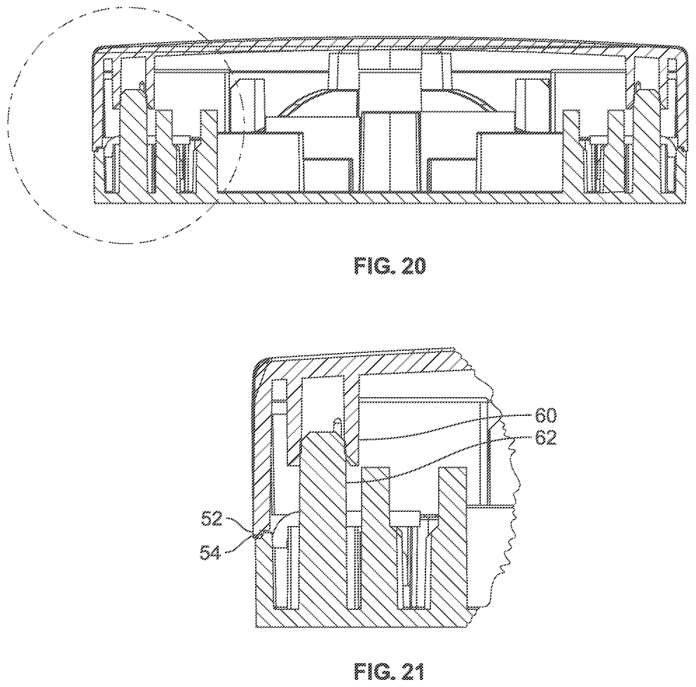

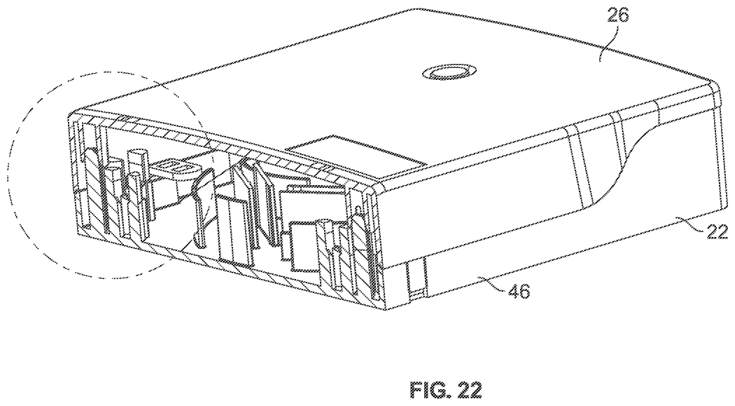

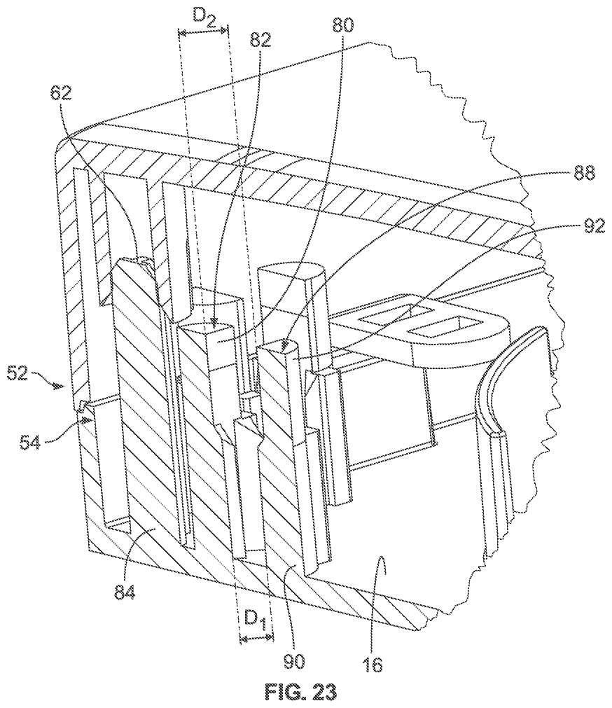

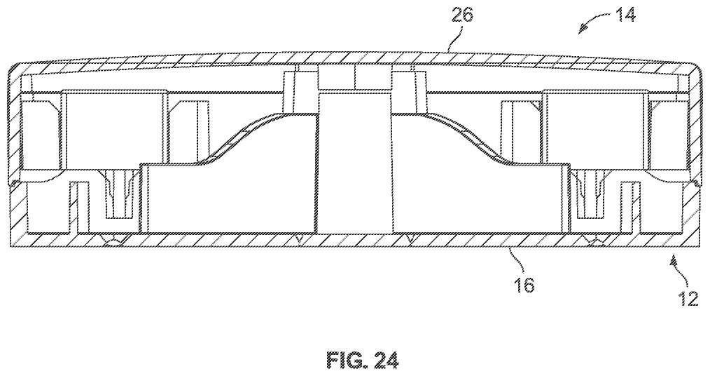

Referring to FIGS. 1-24, the embodiments to the termination box of the present disclosure are described in further detail. In the depicted embodiment, the termination box is a telecommunication housing 10 that includes a base 12 and a cover 14. In the depicted embodiment, the cover 14 mates with the base 12. The cover 14 and base 12 cooperatively provide a space wherein fiber cables can be terminated, spliced, connected, and otherwise managed.

In the depicted embodiment, the base 12 includes a base floor 16, a primary base wall 18 extending away from the base floor 16, a secondary base wall 20 extending away from the base floor 16, a first side base wall 22 extending away from the base floor 16, and a second side base wall 24 extending away from the base floor 16. It should be appreciated that many alternative configurations are possible.

In the depicted embodiment, the base floor 16 is rectangular, and the primary base wall 18, secondary base wall 20, first side base wall 22 and second side base wall 24 extend perpendicularly from periphery edges of the base floor 16. In the depicted embodiment, the first side base wall 22 includes a first end portion that is connected to the primary base wall 18 and a second end portion that is connected to the secondary base wall 20. In the depicted embodiment, the second side base wall 24 includes a first end portion that is connected to the primary base wall 18 and a second end portion that is connected to the secondary base wall 20. In the depicted embodiment, the base 12 is in the general shape of a tray. It should be appreciated that many alternative configurations are possible.

In the depicted embodiment, the cover 14 includes a main body 26, a first cover portion 28 connected to the main body 26 and configured to mate with the primary base wall 18 of the base 12, a second cover portion 30 connected to the main body 26 and configured to mate with the secondary base wall 20 of the base 12, a third cover portion 32 connected to the main body 26 and configured to mate with the first side base wall 22 of the base 12, and a fourth cover portion 34 connected to the main body 26 and configured to mate with the second side base wall 24 of the base 12. In the depicted embodiment, the cover 14 shares the same general periphery shape as the base 12. It should be appreciated that many alternative configurations are possible.

In the depicted embodiment, the first cover portion 28 includes a cover lip 36 that extends perpendicularly away from the main body 26 of the cover 14. In the depicted embodiment, the second cover portion 30 includes a rear wall 38 that extends perpendicularly away from the main body 26 of the cover 14. In the depicted embodiment, the third cover portion 32 includes a first side cover wall 40 that extends perpendicularly away from the main body 26 of the cover 14 and is connected to the cover lip 36 and the rear wall 38. In the depicted embodiment, the fourth cover portion 34 includes a second side cover wall 42 that extends perpendicularly away from the main body 26 of the cover 14 and is connected to the cover lip 36 and the rear wall 38. It should be appreciated that the terms “rear” and “front” as used herein are not meant to be limiting. Directional terms such as “rear” and “front” are used herein to provide a frame of reference to facilitate in the description of the disclosed embodiment. It should be appreciated that in the field, the telecommunication housing 10 can be mounted in a number of different orientations. The telecommunication housing 10 can be mounted such that any surface is oriented at the top, bottom, rear, and front.

In the depicted embodiment, the base 12 is injection molded. In the depicted embodiment, the base 12 is configured to be molded in a two piece mold and hence does not include any substantial undercuts or other features that would prevent it from being moldable in a two piece mold. In the depicted embodiment, the cover 14 is also injection molded. The cover 14 is also configured to be molded in a two piece mold and hence does not include any substantial undercuts or other features that would prevent it from being moldable in a two piece mold. It should be appreciated that many alternative configurations are possible. For example, the base 12 and cover 14 could alternatively be molded with three-piece plus molds and include undercuts.

In the depicted embodiment, the first side cover wall 40 of the cover 14 and the first side base wall 22 of the base 12 cooperatively define a first housing side 44 of the housing 10. In the depicted embodiment, the first housing side 44 of the housing 10 has a constant height H1. It should be appreciated that height H1 can have a wide range of magnitudes, for example, 10 to 100 mm, 15 to 40 mm, 20 to 30 mm, etc. In the depicted embodiment, the first side base wall 22 of the base 12 includes a low sidewall portion 46 that has a height H2 that is between 20 percent and 60 percent of the height H1 of the first housing side 44. It should be appreciated that many other percentage ranges are also possible, for example, 30 to 50 percent, 35 to 45 percent, etc. In one configuration, height H1 is 23 mm and height H2 is 9 mm, which makes height H2 40 percent of height H1. In the depicted embodiment, the second cover portion 30 of the cover 14 and the second side base wall 24 of the base 12 cooperatively define a second housing side 48 of the housing 10. In the depicted embodiment, the second housing side 48 has a constant height H3. In the depicted embodiment, the second side base wall 24 includes a low sidewall portion 50 that has a height H4 that is between 20 percent and 60 percent of height H3. In the depicted embodiment, the height H1 and the height H3 are the same. The depicted configuration allows the users to more easily install fiber optic connectors and/or adapters in the housing. The low sidewall portion 50 facilitates finger access so that the user can hold the sides of the adapter during installation and removal of the fiber optic adapter from the housing or to remove the connector from the adapter. It should be appreciated that many alternative configurations are possible.

As discussed above, in the depicted embodiment, the cover 14 mates with the base 12. In the depicted embodiment, a portion of the periphery of the cover 14 overlaps with a portion of the base 12. In the depicted embodiment, the distal edge of the cover lip 36, rear wall 38, first side cover wall 40, and second side cover wall 42 of the cover 14 overlaps with the distal edge of the primary base wall 18, secondary base wall 20, first side base wall 22, and second side base wall 24 of the base 12. In the depicted embodiment, a portion of the periphery of the base 12 has a stepped profile. In the depicted embodiment, the distal edge portion 52 of the cover 14 that overlaps with the base 12 mates with a shoulder 54 on the base 12. In the depicted embodiment, the distal edge portion 52 of the cover 14 also includes a stepped profile. The depicted configuration results in a sealed connection between the cover 14 and the base 12. It should be appreciated that many alternative configurations are possible.

In the depicted embodiment, the first housing side 44 forms a generally continuous surface. The second housing side 48 also forms a continuous surface. In the depicted embodiment, the first side base wall 22 of the base 12 includes a generally flat exterior surface and the first side cover wall 40 of the cover 14 includes a generally flat exterior surface. In the depicted embodiment, the generally flat exterior surface of the first side base wall 22 and the first side cover wall 40 is flush relative to each other. The depicted configuration provide a unitary look as the cover 14 and the base 12 cooperatively defined an enclosure having a generally smooth exterior surface. It should be appreciated that many alternative configurations are possible.

In the depicted embodiment, the telecommunication housing 10 of the present disclosure also includes a latching system that secures the cover 14 to the base 12. In the depicted embodiment, the latching system includes a latch portion 56 of the base 12 or cover 14 that deflects when the cover 14 is pressed onto the base 12. In the depicted embodiment, the base 12 includes a tab portion 58 that when depressed releases the latch system. It should be appreciated that many alternative configurations are possible. It should also be appreciated that many alternative embodiments would not include the disclosed latching system.

In the depicted embodiment, the telecommunication housing 10 of the present disclosure also includes an internal cover retention system. In the depicted embodiment, the cover retention system includes a post 58 that is axially aligned with an aperture 60. When the cover 14 is pressed onto the base 12, the post 62 presses into the aperture 60 and creates an inference connection therebetween. In the depicted embodiment, the cover retention system includes posts 62, 64 and aligned apertures 60 in corners of the telecommunication housing 10. In the depicted embodiment, the posts 62, 64 extend from the base floor 16 and include self-aligning distal ends. The apertures 60 are barrel-shaped and extend from the main body 26 of the cover 14. The self-aligning distal ends of the posts 62, 64 are driven into engagement with the barrel-shaped apertures 60 when the cover 14 is pressed into engagement with the base 12. It should be appreciated that many alternative configurations are possible. For example, in alternative embodiments the base 12 and the cover 14 can be held securely together via a friction fit, a snap fit, fasteners, adhesive, or any other means.

In the depicted embodiment, the telecommunication housing 10 includes a fastener port 74. In the depicted embodiment, the fastener port 74 can be used to secure the cover 14 to the base 12 as well as secure the base 12 to another mounting surface (e.g., a wall, ceiling, floor, etc.). In the depicted embodiment, the fastener port 74 extends through the telecommunication housing 10 and largely isolates the fastener that extend through the fastener port 74 from the inside of the telecommunication housing 10. The configuration in the depicted embodiment aids in keep foreign matter from entering the telecommunication housing 10 through the fastener port 74. In the depicted embodiment, the configuration avoids the undesirable outcome of the fastener port 74 inadvertently damaging the contents inside the telecommunication housing 10. In the depicted embodiment, the fastener port 74 includes a cover collar 76 extending from an inside surface of the main body 26 of the cover 14 that is coaxially aligned and coincident with a base collar 78 that extends from the base floor 16 of the base 12. It should be appreciated that many alternative configurations are possible.

In the depicted embodiment, the telecommunication housing 10 includes at least one cable entry point configured to allow a cable to access the telecommunication housing 10. In the depicted embodiment, the telecommunication housing 10 includes a plurality of cable entry points 80, 96, 98, 160, 162, 164, 166. In the depicted embodiment, the cable entry points 80, 96, 98, 160, 162, 164, 166 are frangible portions on the housing 10 that are configured to be broken away in the field to allow a cable to access or exit the housing 10 to meet the needs for the particular installation. It should be appreciated that many alternative configurations are possible. The number of entry points can be 1, 2, 3, 4, 5, 6, 7, 8, 9, 10, or more. The location can be the same wall, two walls, three walls, four walls, or five walls.

In the depicted embodiment, the telecommunication housing 10 includes cable securing assemblies located within the housing 10 adjacent cable entry points 80, 96, 98, 160, 162, 164, 166. In the depicted embodiment, the cable securing assembly includes a first cable securing post 82 having a base end 84 and a distal end 86. The base end 84 extends from the base floor 16. The cable securing assembly includes a second cable securing post 88 having a base end 90 and a distal end 92. The base end 90 extends from the base floor 16. In the depicted embodiment, the distal ends 86, 92 of the first and second cable securing posts 82, 88 terminate at a distance within 1 mm to 10 mm from the inner surface of the cover 14 (e.g., 1 to 5 mm, 2 to 4 mm, etc.). In the depicted embodiment, the inner surface of the cover 14 opposite the top portion of the first and second cable securing posts 82, 88 is flat and non-featured. It should be appreciated that many alternative configurations are possible.

In the depicted embodiment, the cable securing assembly includes a closure 94 that draws the first and second cable securing posts 82, 88 towards each other to apply a clamping force on a cable located therebetween. The closure 94 can be, for example, a zip tie as illustrated. In the depicted embodiment, the distance D1 between the base ends 84, 90 of the first and second cable securing posts 82, 88 is smaller than the distance D2 between the distal ends 86, 92 of the first and second cable securing posts 82, 88. In one configuration, the distance D1 is 1.8 mm and the distance D2 is 2.5 mm. It should be appreciated that many other numerical values are also possible for the distance D1 and the distance D2. In the depicted embodiment, the first and second cable securing posts 82, 88 are configured to plastically bend towards each other to retain the cable therebetween. The plastic deformation can be, as described above, deflection toward each other via a force imparted via a closure 94. The bending can also be away from each other due to the force of the cable being driven between the securing posts 82, 88. In the depicted embodiment, the first and second cable securing posts 82, 88 include wedge-shaped inside profiles that are configured to bite onto the sheath of a cable. It should be appreciated that many alternative configurations are possible.

As discussed above, the telecommunication housing 10 of the depicted embodiment includes a number of cable entry points 80. In the depicted embodiment, the telecommunication housing 10 includes an adapter cable entry point 100 configured to receive a portion of a fiber optic adapter 102. In the depicted embodiment, the base 12 includes first and second adapter securing slots 104, 106 that extend from the base floor 16 adjacent the adapter cable entry point 100. The adapter securing slots 104, 106 include a first flange 108 that extends from and away from the base floor 16 and a second flange 110 that extends from and away from the base floor 16. The distance between the flanges F1 is between 3 and 4 mm. In the depicted embodiment, the base 12 includes a cable retaining channel 112 located adjacent the adapter cable entry point 100 for the fiber optic adapter 102. In the depicted embodiment, the cable retaining channel 112 includes a first side 114 of the channel 112 and a second side 116 of the channel 112. It should be appreciated that many alternative configurations are possible.

In the depicted embodiment, the telecommunication housing 10 includes a cable bend management system 118. In the depicted embodiment, the cable bend management system 118 includes a first cable path guide 120 and a second cable path guide 122. In the depicted embodiment, each of the first and the second cable path guides 120, 122 is an arcuate flange that extends from the base floor 16. In the depicted embodiment, at least two discrete cable path guides 120, 122 define a generally circular path on the base floor 16 when viewed from above. It should be appreciated that many alternative configurations are possible.

In the depicted embodiment, the cable bend management system 118 includes splice protectors 124, 126. In the depicted embodiment, the splice protectors 124, 126 include first straight walls 128, 130 that extend from the base floor 16 that are adjacent to the second straight walls 132, 134 that also extend from the base floor 16. In the depicted embodiment, the splice protectors 124, 126 are at an angle relative to the primary base wall 18, secondary base wall 20, first side base wall 22, and second side base wall 24. It should be appreciated that many alternative configurations are possible.

In the depicted embodiment, the cable bend management system 118 includes cable holders 136, 138. In the depicted embodiment, the cable holders 136, 138 are adjacent to the splice protectors 124, 126 and share some of its structure. In the depicted embodiment, the cable holders 136, 138 are defined between the second straight walls 132, 134 of the splice protectors 124, 126 and the third walls 140, 142 that are adjacent to the second straight walls 132, 134. It should be appreciated that many alternative configurations are possible.

In the depicted embodiment, the cable bend management system 118 includes a pair of C-shaped cable mandrels 144, 146 that extend from the base floor 16. The C-shaped cable mandrels 144, 146 face each other and are in a middle portion of the base 12 between the primary wall 18 and the secondary wall 20 of the base 12. It should be appreciated that many alternative configurations are possible.

In the depicted embodiment, the cable bend management system 118 includes retention tabs 148, 150. The retention tabs 148, 150 are located between the cover 14 and the base 12. In the depicted embodiment, each retention tab 148, 150 includes a first leg 152 and a second leg 154 that are in an L-shaped configuration. The first leg 152 is configured to be inserted into a leg receiving slot 156 in the base 12. In the depicted embodiment, the second leg 154 extends a direction parallel to the base floor 16. It should be appreciated that many alternative configurations are possible.

The present disclosure also provides a method of terminating and connecting a fiber optic cable at a premise. An embodiment of the method includes the step of securing a fiber optic adapter into an enclosure base. The step of securing the fiber optic adapter into the enclosure base can include aligning the fiber optic adapter with vertical slots in the enclosure base. The step of routing a fiber optic cable that is connected to the fiber optic adapter through the enclosure base can include the step of routing the fiber optic cable up and out through an outlet in the enclosure base. The step of routing the fiber optic cable through the enclosure can include the step of routing the fiber optic cable around bend radius mandrels that are located in the enclosure base. The step of securing the cable inside the enclosure base adjacent the outlet by deflecting two cable-holding fingers on either side of the cable toward each other to apply a clamping force on the exterior of the cable. The step of engaging an enclosure cover with the enclosure base. The step of engaging the enclosure cover with the enclosure base can include the step of aligning the enclosure cover with the enclosure base and pressing the enclosure cover into engagement with the enclosure base. It should be appreciated that many alternative configurations are possible.

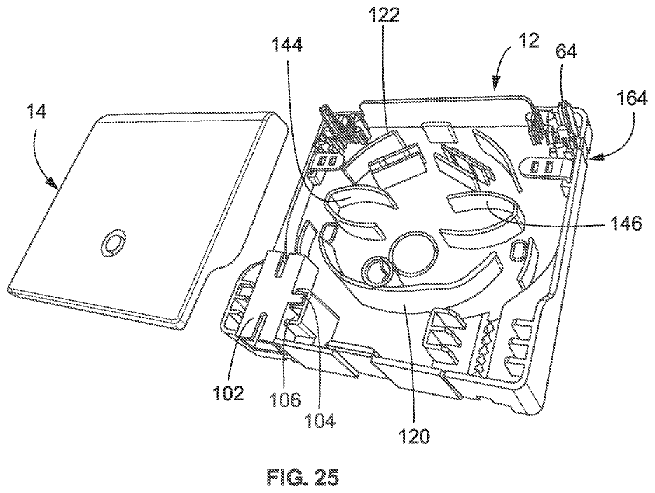

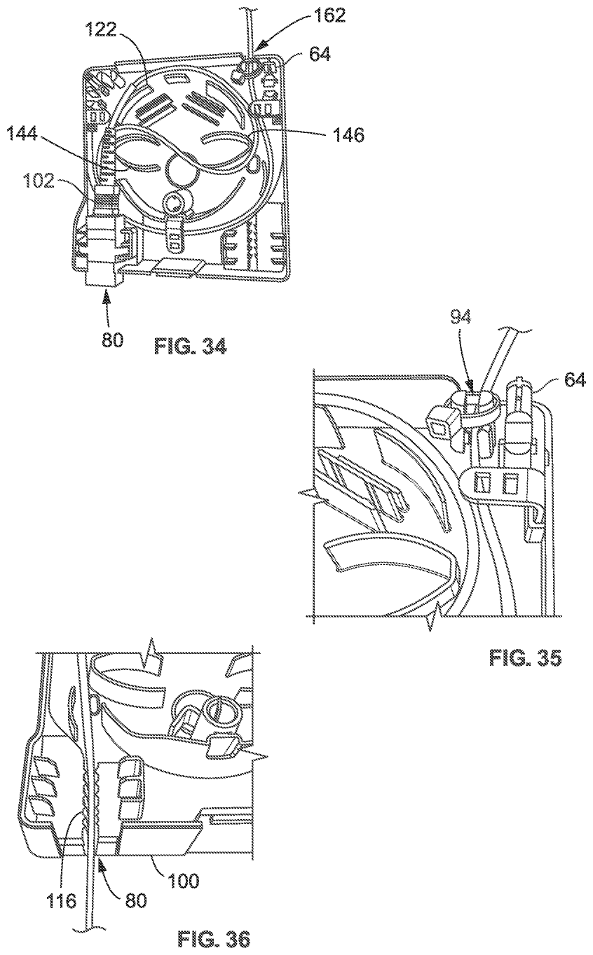

Referring to FIGS. 25-41, the telecommunication housing 10 is shown with telecommunication components therein. The telecommunication housing 10 can be configured in a number of different ways. A few configurations are shown in the figures.

FIG. 25 is an isometric view of the cover 14 and base 12 with a fiber optic adapter 102 secured therein. In the depicted embodiment, the fiber optic adapter 102 has side flanges that fit into slots 104, 106.

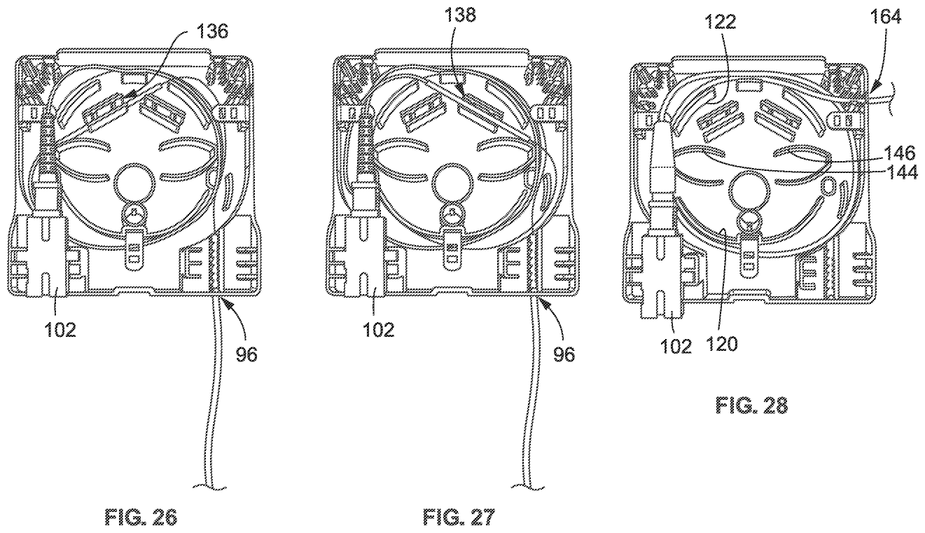

FIGS. 26-28 illustrate that the telecommunication housing 10 is compatible with FIC—Field installable connectors, splice pigtails, and pre-terminated drops. FIGS. 26-28 depict a telecommunication housing 10 that includes a 60 mm central mandrel, which equals 188 mm in circumference. The depicted embodiment of the telecommunication housing 10 includes four SMOUV holders and two ANT holders. More or less splice holders can be provided, including 1, 2, 3, 4, 5, or more. The splice holders can be the same kind of splices or different kinds of splices (for example, SMOUV type and ANT type). The figures also further illustrate how the adapters 102 can be secured in at least two positions relative to the base 12. See also FIG. 30. In one position, the end face of the adapter 102 is flush with the primary wall 18 of the base 12, and in another configuration, the end face of the adapter 102 extends beyond the primary wall 18 of the base 12. A single adapter can be used, as well as two, if desired. More adapters can be added such as a third, a fourth, or more. The cables and connectors can be single fiber (for example, SC) or multi-fiber (for example, MPO).

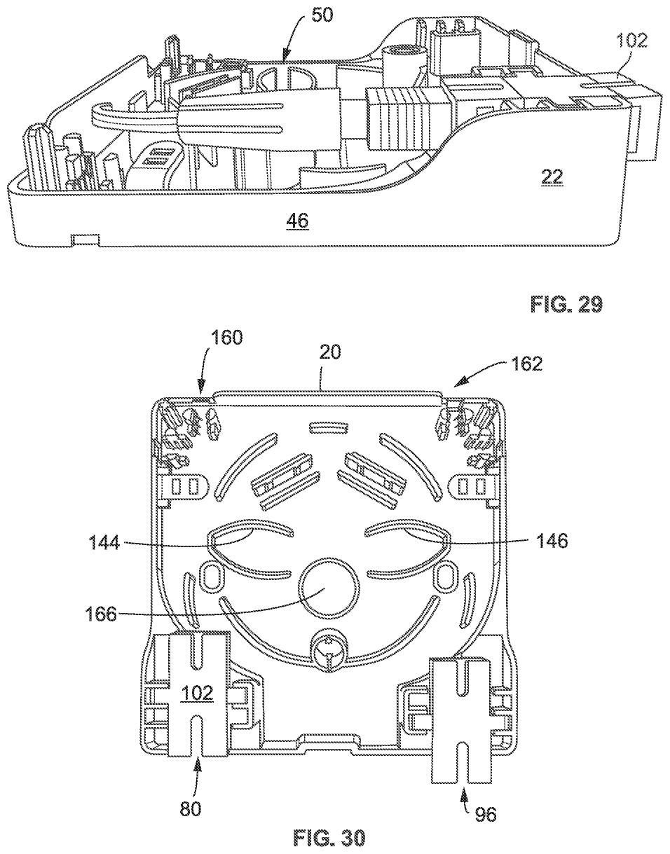

FIG. 29 illustrates how the low side wall portions 46, 50 of the base 12 allow space for human fingers to access the sides of an adapter 102 to facilitate installation and removal.

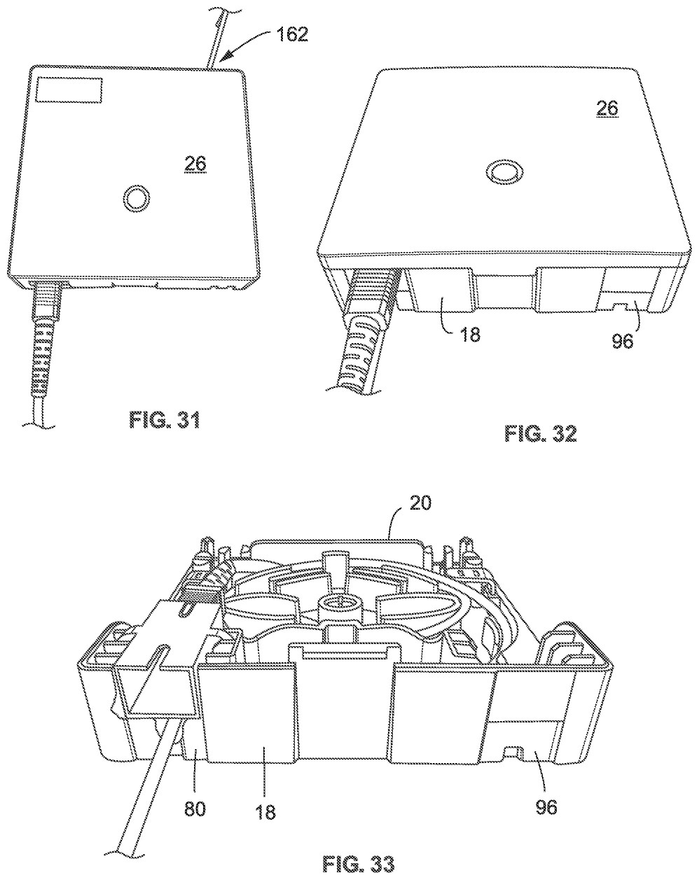

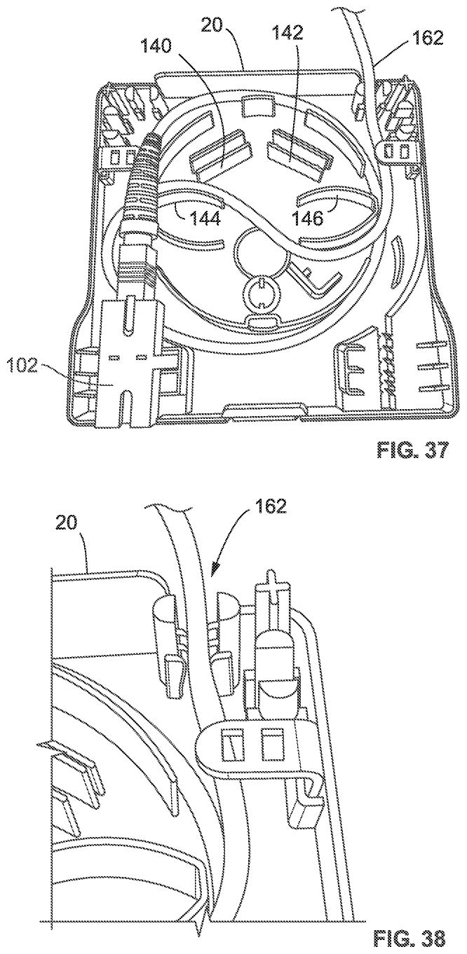

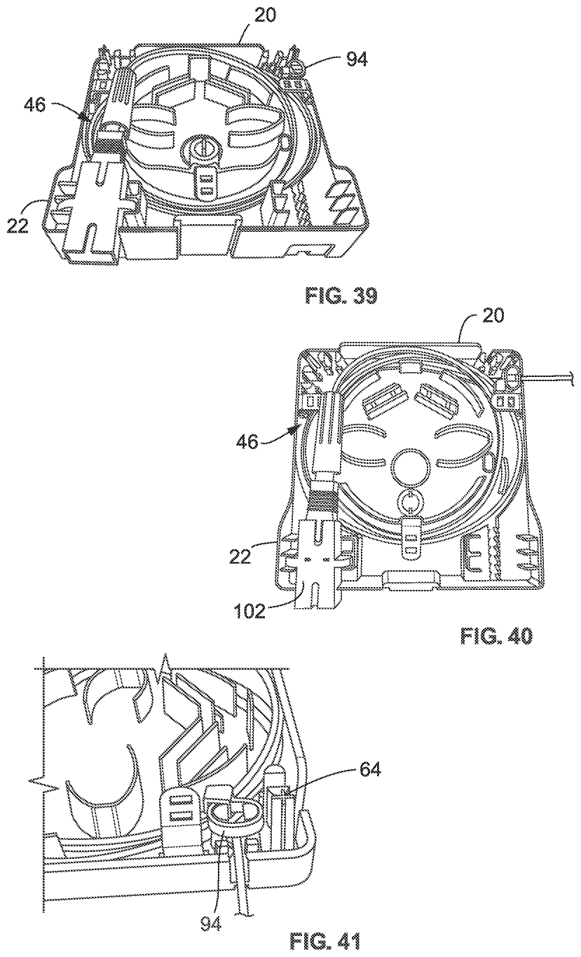

FIGS. 31-36 illustrate a 2 mm cable application. FIGS. 37-38 illustrate a 3 mm round cable application. FIGS. 39-41 illustrate a 3×2 mm cable application and FIC termination with a 0.5 m cable storage. In each of the embodiments, different combinations of cable entry points 80, 86, 98, 160, 162, 164, 166 are utilized. In addition, the cables are routed within the housing 10 differently, thereby utilizing the cable management system in the base 12 differently. It should be appreciated that many other configurations are also possible.

Some of the many aspects of the present disclosure are further described below. An aspect of the present disclosure provides a telecommunication housing that includes a base and a cover. The cover mates with the base. The telecommunication housing also includes cable management structures, splice holders, and cable ports.

In another aspect of the telecommunication housing, the base includes a base floor, a primary base wall extending away from the base floor, a secondary base wall extending away from the base floor, a first side base wall extending away from the base floor, and a second side base wall extending away from the base floor.

In another aspect of the telecommunication housing, the cover includes a main body, a first cover portion connected to the main body and configured to mate with the primary base wall of the base, a second cover portion connected to the main body and configured to mate with the secondary base wall of the base, a third cover portion connected to the main body and configured to mate with the first side base wall of the base, and a fourth cover portion connected to the main body and configured to mate with the second side base wall of the base.

In another aspect of the telecommunication housing, the base has a base floor that is rectangular. The housing includes a primary base wall, a secondary base wall, a first side base wall, and a second side base wall that all extend perpendicularly from periphery edges of the base floor. In this particular aspect, the first side base wall includes a first end portion that is connected to the primary base wall and a second end portion that is connected to the secondary base wall. The second side base wall includes a first end portion that is connected to the primary base wall and a second end portion that is connected to the secondary base wall.

In another aspect of the telecommunication housing, a first housing side of the housing has a constant height H1. In this aspect, the first side base wall includes a low sidewall portion that has a height H2 that is between 20 percent and 60 percent of height H1.

In another aspect of the telecommunication housing, a second housing side has a constant height H3. In this aspect, the second side base wall includes a low sidewall portion that has a height H4 that is between 20 percent and 60 percent of height H3.

In another aspect of the telecommunication housing, the telecommunication housing includes at least one frangible cable entry point configured to allow a cable to access the telecommunication housing. The frangible cable entry point includes a portion configured to be broken away to allow a cable to access or exit the housing.

In another aspect of the telecommunication housing, the telecommunication housing includes a cable securing assembly located within the housing adjacent a cable entry point. The cable securing assembly includes a first cable securing post having a base end and a distal end, the base end of the first cable securing post extending from the base floor. The cable securing assembly includes a second cable securing post having a base end and a distal end, the base end of the second cable securing post extending from the base floor.

In another aspect of the telecommunication housing, the telecommunication housing has an inner surface of the cover opposite the top portion of the first and the second post, and is flat and non-featured.

In another aspect of the telecommunication housing, the telecommunication housing includes the cable securing assembly that includes a closure that draws the first and the second cable securing posts towards each other to apply a clamping force on a cable located therebetween.

In another aspect of the telecommunication housing, the telecommunication housing includes the distance between the base ends of the first and the second cable securing posts that is smaller than the distance between the distal ends of the first and the second cable securing posts.

In another aspect of the telecommunication housing, the first and the second cable securing posts include wedge-shaped inside profiles that are configured to bite onto the sheath of a cable.

In another aspect of the telecommunication housing, the first and the second cable securing posts are configured to plastically bend towards each other to retain the cable therebetween.

In another aspect of the telecommunication housing, the primary base wall of the base defines a first cable entry point. The cable entry point can receive a portion of a fiber optic adapter. The base further comprises a first and a second adapter securing slot that extends from the base floor adjacent the first cable entry point. The adapter securing slot includes a first flange that extends from and away from the base floor and a second flange that extends from and away from the base floor, wherein the distance between the flanges is between 3 and 4 mm.

In another aspect of the telecommunication housing, the primary base wall of the base defines a first cable entry point. The base includes a cable retaining channel located adjacent the first cable entry point, and the cable retaining channel includes a first side of the channel and a second side of the channel.

In another aspect of the telecommunication housing, a portion of a periphery of the cover overlaps with a portion of the base.

In another aspect of the telecommunication housing, an exterior surface of the first side cover wall of the cover portion is flush with an exterior surface of the first side base wall.

In another aspect of the telecommunication housing, a portion of the periphery of the base that is configured to mate with the cover has a stepped profile.

In another aspect of the telecommunication housing, the telecommunication housing includes a latching system that secures the cover to the base. The latching system includes a latch portion of the base or cover that deflects when the cover is pressed onto the base.

In another aspect of the telecommunication housing, the telecommunication housing includes a cover retention system, the cover retention system includes a post that is axially aligned with an aperture. The post presses into the aperture and creates an inference connection therebetween.

In another aspect of the telecommunication housing, the telecommunication housing includes a cover retention system, the cover retention system includes a post that extends from the base floor that is axially aligned with a barrel aperture that extends from the main body of the cover. The post has a self-aligning distal end and is configured to be driven into the barrel aperture.

In another aspect of the telecommunication housing, the telecommunication housing includes a cover retention system, the cover retention system includes a first post that extends from the base floor that is axially aligned with a first barrel aperture that extends from the main body of the cover. The first post has a self-aligning distal end and is configured to be driven into the first barrel aperture. The cover retention system includes second, third, and fourth posts that all have the same feature as the first post, and second, third, and fourth barrel apertures that all have the same feature as the first barrel aperture.

In another aspect of the telecommunication housing, the height H1 and height H3 of the opposed sidewalls are the same.

In another aspect of the telecommunication housing, the telecommunication housing includes a cable bend management system including a plurality of cable path guides. Each cable path guide includes an arcuate flange that extends from the base floor. At least two discrete cable path guides define a generally circular path on the base floor.

In another aspect of the telecommunication housing, the telecommunication housing includes a cable bend management system, the cable bend management system includes a first cable path guide located in a first corner portion of the base floor, the first cable path guide extending from the base floor and having an arcuate profile, and a second cable path guide located in a second corner portion of the base floor, the second cable path guide extending from the base floor and having an arcuate profile, wherein the first and the second cable path guides are spaced apart and cooperatively define portions of a circle when viewed from above.

In another aspect of the telecommunication housing, the telecommunication housing includes a cable bend management system including splice protectors. The splice protectors include two adjacent straight walls that extend from the base floor. The splice protectors are at an angle relative to the primary base wall, the secondary base wall, the first side base wall, and the second side base wall.

In another aspect of the telecommunication housing, the telecommunication housing includes a cable bend management system including a splice protector and a cable holder. The splice protector includes a first wall that extends from the base floor and an adjacent second wall that extends from the base floor. The cable holder is defined between the second wall and a third wall that is adjacent the second wall.

In another aspect of the telecommunication housing, the telecommunication housing includes a cable bend management system including a pair of C-shaped cable mandrels that extend from the base floor, wherein the pair of C-shaped cable mandrels face each other and are in a middle portion of the base between the primary and the secondary wall of the base.

In another aspect of the telecommunication housing, the telecommunication housing includes a cable bend management system including retention tabs. The retention tabs include a first leg and a second leg that are in an L-shaped configuration. The first leg is inserted into a leg receiving slot in the base and the second leg extends in a direction parallel to the base floor.

In another aspect of the telecommunication housing, the telecommunication housing includes an isolated fastener port, the isolated fastener port includes a cover collar extending from an inside surface of the main body of the cover that is coaxially aligned and coincident with a base collar that extends from the base floor.

In another aspect of the telecommunication housing, the base is injection molded and does not include undercuts. The cover is injection molded and does not include undercuts.

In another aspect of the telecommunication housing, the base includes adapter securing slots.

In another aspect of the telecommunication housing, the telecommunication housing includes a portion of the periphery of the cover that overlaps with a portion of the base.

In another aspect of the telecommunication housing, the telecommunication housing includes a cover retention system. The cover retention system includes a post that is axially aligned with an interference aperture. The post presses into the aperture and creates an inference connection therebetween.

In another aspect of the disclosure, a method of terminating and connecting a fiber optic cable at a premise is provided. The method comprises the steps of securing a fiber optic adapter into an enclosure base, routing a fiber optic cable that is connected to the fiber optic adapter through the enclosure base up and out through an outlet in the enclosure base, securing the cable inside the enclosure base adjacent the outlet by deflecting two cable holding fingers on either side of the cable toward each other to apply a clamping force on the exterior of the cable, and engaging an enclosure cover with the enclosure base.

In another aspect of the disclosure, the method comprises the step of engaging the enclosure cover with the enclosure base including aligning the enclosure cover with the enclosure base and pressing the enclosure cover into engagement with the enclosure base.

In another aspect of the disclosure, the method comprises the step of routing the fiber optic cable through the enclosure including routing the fiber optic cable around the bend radius mandrels that are located in the enclosure base.

In another aspect of the disclosure, the method comprises the step of securing the fiber optic adapter into the enclosure base including aligning the fiber optic adapter with the vertical slots in the enclosure base.

The disclosure includes the aspects identified above as well as many others. It should be appreciated that any combination of aspects are possible.

The above specification, examples, and data provide a complete description of the manufacture and use of the disclosure. Since many embodiments and aspects of the disclosure can be made without departing from the spirit and scope of the inventive aspects, the inventive aspects reside in the claims hereinafter appended.

What is claimed is:

1. A telecommunication housing comprising:
a base including a base floor, a primary base wall extending away from the base floor, a secondary base wall extending away from the base floor, a first side base wall extending away from the base floor, and a second side base wall extending away from the base floor;
a cover configured to mate to the base, the cover including a main body, a first cover portion connected to the main body and configured to mate with the primary base wall, a second cover portion connected to the main body and configured to mate with the secondary base wall, a third cover portion connected to the main body and configured to mate with the first side base wall, and a fourth cover portion connected to the main body and configured to mate with the second side base wall;
wherein the base floor is rectangular and the primary base wall, secondary base wall, first side base wall, and second side base wall extend perpendicularly from periphery edges of the base floor;
wherein the first side base wall includes a first end portion that is connected to the primary base wall and a second end portion that is connected to the secondary base wall;
wherein the second side base wall includes a first end portion that is connected to the primary base wall and a second end portion connected to the secondary base wall;
wherein the first side cover wall of the cover and the first side base wall of the base cooperatively define a first housing side of the housing;
wherein the first housing side of the housing has a constant height H1, wherein the first side base wall includes a low side wall portion that has a height H2 that is between 20 percent and 60 percent of height H1;
wherein the second side cover portion of the cover and the second side base wall of the base cooperatively define a second housing side of the housing;
wherein the second housing side of the housing has a constant height H3, wherein the second side base wall includes a low side wall portion that has a height H4 that is between 20 percent and 60 percent of height H3;
wherein the first cover portion includes a cover lip that extends perpendicularly away from the main body of the cover;
wherein the second cover portion includes a rear wall that extends perpendicularly away from the main body of the cover;
wherein the third cover portion includes a first side cover wall that extends perpendicularly away from the main body of the cover and is connected to the cover lip and rear wall; and
wherein the fourth cover portion includes a second side cover wall that extends perpendicularly away from the main body of the cover and is connected to the cover lip and the rear wall.

2. The telecommunication housing of claim 1, further comprising at least one frangible cable entry point configured to allow a cable to access the telecommunication housing, wherein the frangible cable entry point includes a portion configured to be broken away to allow a cable to access or exit the housing.

3. The telecommunication housing of claim 1, further comprising a cable securing assembly located within the housing adjacent a cable entry point, wherein the cable securing assembly includes a first cable securing post having a base end and a distal end, the base end of the first cable securing post extending from the base floor, wherein the cable securing assembly includes a second cable securing post having a base end and a distal end, the base end of the second cable securing post extending from the base floor.

4. The telecommunication housing of claim 3, wherein an inner surface of the cover opposite the top portion of the first and the second post is flat and non-featured.

5. The telecommunication housing of claim 3, wherein the cable securing assembly includes a closure that draws the first and the second cable securing posts towards each other to apply a clamping force on a cable located therebetween.

6. The telecommunication housing of claim 3, wherein the distance between the base ends of the first and the second cable securing posts is smaller than the distance between the distal ends of the first and the second cable securing posts.

7. The telecommunication housing of claim 3, wherein the first and the second cable securing posts include wedge-shaped inside profiles that are configured to bite onto the sheath of a cable.

8. The telecommunication housing of claim 3, wherein the first and the second cable securing posts are configured to plastically bend towards each other to retain the cable therebetween.

9. The telecommunication housing of claim 1,
wherein the primary base wall defines a first cable entry point, wherein the cable entry point can receive a portion of a fiber optic adapter;
wherein the base further comprises a first and a second adapter securing slot that extends from the base floor adjacent the first cable entry point; and
wherein the adapter securing slot includes a first flange that extends from and away from the base floor and a second flange that extends from and away from the base floor, wherein the distance between the flanges F1 is between 3 and 4 mm.

10. The telecommunication housing of claim 1,
wherein the primary base wall defines a first cable entry point, and
wherein the base includes a cable retaining channel located adjacent the first cable entry point, wherein the cable retaining channel includes a first side of the channel and a second side of the channel.

11. The telecommunication housing of claim 1, wherein the portion of the periphery of the cover overlaps with a portion of the base.

12. The telecommunication housing of claim 1, wherein an exterior surface of the first side cover wall of the cover portion is flush with an exterior surface of the first side base wall.

13. The telecommunication housing of claim 1, wherein a portion of the periphery of the base that is configured to mate with the cover has a stepped profile.

14. The telecommunication housing of claim 1, further comprising a latching system that secures the cover to the base, wherein the latching system includes a latch portion of the base or cover that deflects when the cover is pressed onto the base.

15. The telecommunication housing of claim 1, further comprising a cover retention system, the cover retention system includes a post that is axially aligned with an aperture, wherein the post presses into the aperture and creates an inference connection therebetween.

16. The telecommunication housing of claim 1, further comprising a cover retention system, the cover retention system includes a post that extends from the base floor that is axially aligned with a barrel aperture that extends from the main body of the cover, wherein the post has a self-aligning distal end and is configured to be driven into the barrel aperture.

17. The telecommunication housing of claim 1, further comprising a cover retention system, the cover retention system includes a first post that extends from the base floor that is axially aligned with a first barrel aperture that extends from the main body of the cover, wherein the first post has a self-aligning distal end and is configured to be driven into the first barrel aperture, wherein the cover retention system includes second, third, and fourth posts that all have the same feature as the first post, and second, third, and fourth barrel apertures that all have the same feature as the first barrel aperture.

18. The telecommunication housing of claim 1, wherein the first side base wall includes a portion that has a height of between 30 and 50 percent of height H1.

19. The telecommunication housing of claim 1, wherein the height H1 and the height H3 are the same.

20. The telecommunication housing of claim 1, further comprising a cable bend management system including a plurality of cable path guides, wherein each cable path guide includes an arcuate flange that extends from the base floor, wherein at least two discrete cable path guides define a generally circular path on the base floor.

21. The telecommunication housing of claim 1, further comprising a cable bend management system, the cable bend management system including:
a first cable path guide located in a first corner portion of the base floor, the first cable path guide extending from the base floor and having an arcuate profile; and
a second cable path guide located in a second corner portion of the base floor, the second cable path guide extending from the base floor and having an arcuate profile,
wherein the first and the second cable path guides are spaced apart and cooperatively define portions of a circle when viewed from above.

22. The telecommunication housing of claim 1, further comprising a cable bend management system including splice protectors, wherein the splice protectors include two adjacent straight walls that extend from the base floor, wherein the splice protectors are at an angle relative to the primary base wall, secondary base wall, first side base wall, and second side base wall.

23. The telecommunication housing of claim 1, further comprising a cable bend management system including a splice protector and a cable holder, wherein the splice protector includes a first wall that extends from the base floor and an adjacent second wall that extends from the base floor, wherein the cable holder is defined between the second wall and a third wall that is adjacent the second wall.

24. The telecommunication housing of claim 1, further comprising a cable bend management system including a pair of C-shaped cable mandrels that extend from the base floor, wherein the pair of C-shaped cable mandrels face each other and are in a middle portion of the base between the primary and the secondary wall of the base.

25. The telecommunication housing of claim 1, further comprising a cable bend management system including retention tabs, wherein the retention tabs include a first leg and a second leg that are in an L-shaped configuration, wherein the first leg is inserted into a leg receiving slot in the base and the second leg extends in a direction parallel to the base floor.

26. The telecommunication housing of claim 1, further comprising an isolated fastener port, the isolated fastener port includes a cover collar extending from an inside surface of the main body of the cover that is coaxially aligned and coincident with a base collar that extends from the base floor.

27. A telecommunication housing comprising:
a base including a base floor, a primary base wall extending away from the base floor, a secondary base wall extending away from the base floor, a first side base wall extending away from the base floor, and a second side base wall extending away from the base floor;
a cover configured to mate to the base, the cover including a main body, the cover including a first cover portion connected to the main body and configured to mate with the primary base wall, a second cover portion connected to the main body and configured to mate with the secondary base wall, a third cover portion connected to the main body and configured to mate with the first side base wall, and a fourth cover portion connected to the main body and configured to mate with the second side base wall;
wherein the base is injection molded and does not include undercuts;
wherein the cover is injection molded and does not include undercuts;
wherein the base defines a cable entry point configured to allow a cable to access the telecommunication housing; and
wherein the base includes a cable securing assembly located within the housing adjacent a cable entry point.

28. The telecommunication housing of claim 27, wherein the base includes adapter securing slots.

29. The telecommunication housing of claim 27, wherein the portion of the periphery of the cover overlaps with a portion of the base.

30. The telecommunication housing of claim 27, further comprising a cover retention system, the cover retention system includes a post that is axially aligned with an interference aperture, wherein the post presses into the aperture and creates an inference connection therebetween.

31. A method of terminating and connecting a fiber optic cable at a premise comprising the steps of:
securing a fiber optic adapter into an enclosure base;
routing a fiber optic cable that is connected to the fiber optic adapter through the enclosure base up and out through an outlet in the enclosure base;
securing the cable inside the enclosure base adjacent the outlet by deflecting two cable holding fingers on either side of the cable toward each other to apply a clamping force on the exterior of the cable; and
engaging an enclosure cover with the enclosure base.

32. The method of claim 31, wherein the step of engaging the enclosure cover with the enclosure base includes aligning the enclosure cover with the enclosure base and pressing the enclosure cover into engagement with the enclosure base.

33. The method of claim 31, wherein the step of routing the fiber optic cable through the enclosure includes routing the fiber optic cable around bend radius mandrels that are located in the enclosure base.

34. The method of claim 31, wherein the step of securing the fiber optic adapter into the enclosure base includes aligning the fiber optic adapter with vertical slots in the enclosure base.
